(19) United States
(12) Patent Application Publication
(10) Pub. No.: US 2015/0163701 A1
(43) Pub. Date: Jun. 11, 2015

(54) MANAGING VOICE CALLS IN CSFB DEVICES

(71) Applicant: QUALCOMM Incorporated, San Diego, CA (US)

(72) Inventors: Rao Sanyasi YENAMANDRA, San Diego, CA (US); Naveen KALLA, San Diego, CA (US); Rajat PRAKASH, San Diego, CA (US); Ramesh SATHYANARAYANA, San Diego, CA (US)

(21) Appl. No.: 14/560,851

(22) Filed: Dec. 4, 2014

Related U.S. Application Data
(60) Provisional application No. 61/912,394, filed on Dec. 5, 2013.

(51) Int. Cl. H04W 36/00; H04W 60/00; H04W 36/30

(52) U.S. Cl. CPC H04W 36/0022; H04W 36/30; H04W 60/005

(57) ABSTRACT

The disclosure provides for managing voice calls in Circuit Switched Fall Back (CSFB) communication devices that are configured to make voice calls using both Circuit Switched (CS) networks and Internet Protocol (IP) over Packet Switched (PS) networks. The device may determine, when registered with a PS network, a signal strength of a CS network at the device. The device may select, based on the signal strength of the CS network, one of the CS network and the PS network for the voice call. The device may establish the voice call using the selected network. The device may receive a user request for initiating a voice call, and initiate a voice call over the selected network automatically using an application corresponding to the selected network. The device may also register with a voice over IP (VoIP) service over the PS network based on the signal strength of the CS network.

### CLAIM OF PRIORITY

This application claims priority to U.S. Provisional Application Ser. No. 61/912,394, entitled “Systems and Methods for Managing Voice Calls in CSFB Devices,” filed on Dec. 5, 2013, assigned to the assignee hereof and expressly incorporated by reference herein in its entirety.

### BACKGROUND

This application generally relates to managing voice calls on wireless devices. In particular, this application relates to managing voice calls in Circuit-Switched Fall Back (CSFB) devices.

Mobile devices, such as smartphones, may have multiple ways to make a voice call. For example, a mobile device may execute an Over-The-Top (OTT) Voice over Internet Protocol (VoIP) application to make a voice call on a Long Term Evolution (LTE) or WiFi network. The mobile device also may execute a built-in dialer application to make a Circuit Switching (CS) voice call over a CDMA 2000 1x network, Global System for Mobile Communication (GSM) network, Wideband Code Division Multiple Access (WCDMA), or other wireless network. A user of the mobile device typically has to decide which method a voice call is to be made. If one method fails, the user has to choose another method for making the voice call.

With a CSFB-capable communication device, if the device is connected to, camped on, or otherwise associated with LTE and when a voice call is made, the device may switch to the CDMA 1x network, WCDMA network, or GSM network to make the voice call. Nevertheless, the CSFB-capable communication device may fail to make the voice call because the CSFB-capable communication device may not monitor the signals of these CS networks and may be unable to receive CS network signals when it enters an area where CS network signals are weak. When the CSFB-capable communication device does not find a voice capable network to register, the CSFB-capable communication device may be out of service for an extended period of time and may search for a voice capable network to camp on. Although the CSFB-capable communication device may make a voice call using an OTT VoIP application, the user has to actively choose and open an OTT VoIP application to make the voice call out of the many such apps on the CSFB-capable communication device. Thus, the failed voice calls and the additional steps for making VoIP calls may cause inconvenience to the users.

In view of the foregoing, it may be understood that there may be significant problems and shortcoming associated with current voice call technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Apparatuses and methods are disclosed for managing voice calls in communication devices that are configured to make voice calls using both CS networks and IP networks, e.g., via WiFi network. In particular, the communication devices may be configured to detect a signal strength of the CS network or use broadcast signals from the CS network before or as soon as a voice call attempt is made. The communication device may then determine whether to make a voice call via the CS network or the IP network based on the detected signal strength or other information available from the CS network.

In an aspect, the disclosure provides a method of managing voice calls for wireless communications. The method may include determining, by a device registered with a PS network, a signal strength of a CS network at the device. The method may further include selecting, based on the signal strength of the CS network, a network from one of the CS network and the PS network for a voice call. The method may also include establishing the voice call using the selected network.

In another aspect, the disclosure provides an apparatus for managing voice calls for wireless communications. The apparatus may include a signal detecting component configured to determine, at a device registered with a PS network, a signal strength of a CS network at the device. The apparatus may additionally include a voice call manager configured to select, based on the signal strength of the CS network, a network from one of the CS network and the PS network for a voice call. The apparatus may further include a phone call application component configured to establish the voice call over the CS network. The apparatus may also include a VoIP application component configured to establish the voice call over the PS network.

Another aspect of the disclosure provides another apparatus for managing voice calls for wireless communications. The apparatus may include means for determining, at a device registered with a PS network, a signal strength of a CS network at the device. The apparatus may further include means for selecting, based on the signal strength of the CS network, a network from one of the CS network and the PS network for a voice call. The apparatus may also include means for establishing the voice call using the selected network.

In another aspect, the disclosure provides a computer readable medium storing computer executable code. The computer readable medium may include code for determining, by a device registered with a PS network, a signal strength of a CS network at the device. The computer readable medium may also include code for selecting, based on the signal strength of the CS network, a network from one of the CS network and the PS network for a voice call. The computer readable medium may further include code for establishing the voice call using the selected network. The computer readable medium may comprise a non-transitory computer readable medium.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

FIG. 1 shows a system for managing voice calls for CSFB-capable communication devices according to an aspect of the present disclosure.

FIG. 2 shows a flowchart of a process for establishing a voice call at a CSFB-capable communication device according to an aspect of the present disclosure.

FIG. 3 shows a flowchart of a process for initiating a voice call from a CSFB-capable communication device according to an aspect of the present disclosure.

FIG. 4 shows a flowchart of a process for receiving a voice call at a CSFB-capable communication device according to an aspect of the present disclosure.

FIG. 5 shows a flowchart of a process for routing a voice call to a CSFB-capable communication device according to according to an aspect of the present disclosure.

FIG. 6 is a block diagram of a computer system suitable for implementing voice calls according to according to an aspect of the present disclosure.

FIG. 7 shows a diagram illustrating a wireless communication network, in accordance with certain aspects of the present disclosure.

FIG. 8 illustrates a block diagram of a user equipment (UE) and other network entities.

FIG. 9 illustrates an example call flow of a CSFB procedure when a UE makes a mobile originating (MO) call, according to certain aspects of the present disclosure.

FIG. 10 illustrates an example call flow of a CSFB procedure when a UE receives a mobile terminating (MT) call, according to certain aspects of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

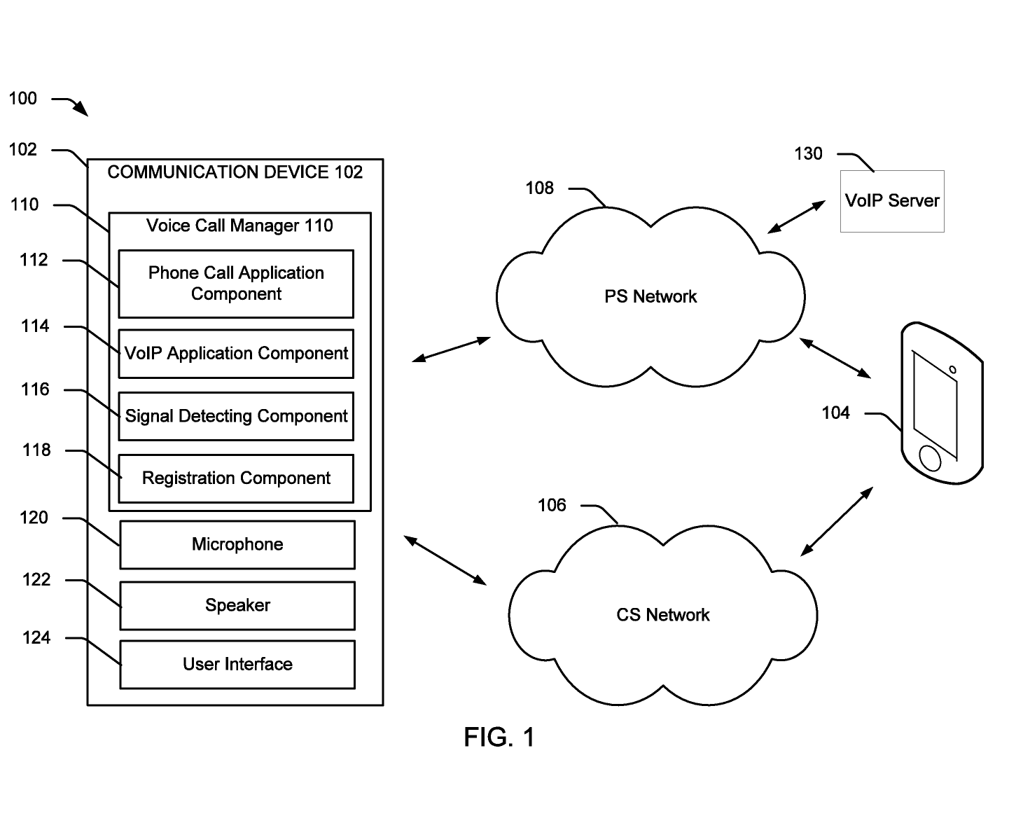

Systems and methods are disclosed for managing voice calls for a CSFB communication device. FIG. 1 is a networked system 100 configured to implement a process for managing voice calls for a CSFB-capable communication device. Networked system 100 may include a plurality of servers and/or software components that allow communication of information. Networked system 100 also may include other network devices that facilitate communication of information.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (WiFi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

Networked system 100 may include a communication device 102, a communication device 104, a Circuit Switched (CS) network 106, and a packet switched (PS) network 108. The CS network may be a CDMA 1x network, a UMTS network, or a GSM network configured to facilitate circuit switched voice calls. In CS network 106, each phone call may have its own dedicated communication channel. PS network 108 may be any packet switched network that supports internet protocol (IP). For example, the PS network 108 may be a wireless wide area network (WWAN) such as an LTE network or a wireless local area network (WLAN) such as a WiFi network. The PS network 108 may also be referred to as an IP network. In PS network 108, voice calls are facilitated using data packets transmitted through shared networks to a destination (terminating) device, for example, device 104. PS network 108 may be a single network or a combination of multiple networks, e.g., the Internet. A VoIP server 130 may also be connected to or in communication with the PS network 108. The VoIP server 130 may facilitate VoIP calls over the PS network 108. Communication devices 102 and 104 may each include one or more processors, memories, and other appropriate components for executing program instructions stored on one or more computer readable mediums to implement various applications.

Communication device 102 may be implemented as a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Communication device 102 may be a CSFB-capable communication device configured to implement voice calls using CS network 106 and/or PS network 108. In an aspect, the communication device 102 may be a voice-centric CSFB-capable communication device configured to use a CSFB procedure to establish voice calls over the CS network 106. For example, communication device 102 may include a voice call manager 110 configured to select between the CS network 106 and the PS network 108 for voice calls. The voice call manager 110 may include hardware and/or software code executable by a processor for automatically selecting one of the CS network 106 and the PS network 108 for a voice call. For example, the voice call manager 110 may automatically select a network based on the signal strength of the CS network 106. When initiating a mobile originated (MO) voice call, the voice call manager 110 may initiate the voice call automatically using the selected network. The voice call manager 110 may also register the communication device 102 with a VoIP service based on the selected network so that mobile terminated (MT) voice calls are automatically received at the communication device 102 over the selected network. The voice call manager 110 may include a phone call application component 112, a VoIP application component 114, a signal detecting component 116, and a registration component 118. The communication device 102 may also include a microphone 120, speaker 122, and user interface 124. In an aspect, the term “component” as used herein may be one of the parts that make up a system, may be hardware, firmware, and/or software, and may be divided into other components.

The phone call application component 112 may include hardware and/or software code executable by a processor for making and receiving voice calls via CS network 106. The phone call application component 112 may be a built-in dialer application that allows a user to dial a telephone number for making a voice call.

The VoIP application component 114 may include hardware and/or software code executable by a processor for making and receiving voice calls via PS network 108. The VoIP application component 114 may be an OTT VoIP application configured to make a voice call using IP. As an OTT VoIP application, the VoIP application component 114 may not depend on the architecture of an access network. Instead, the VoIP application component 114 may use any IP connection. For example, the VoIP application component 114 may use an IP connection provided by an LTE network or a WLAN network such as a WiFi network. The VoIP application component 114 may also be configured to make a voice call over an HSPA/HSPA+ network. In an aspect, the VoIP application component 114 may communicate with a VoIP server 130 over the PS network 108. The VoIP server may, for example, be a session initiation protocol (SIP) server to route calls to the VoIP application component 114. In another aspect, the VoIP server may use a proprietary VoIP protocol such as Skype protocol to route VoIP calls. The VoIP application component 114 may register with a VoIP service hosted by the VoIP server 130. The VoIP application component 114 may require user credentials such as, for example, a username and/or password. The voice call manager 110 may store the user credentials to use as necessary. The VoIP service may also have a separate accounting system from an operator of the CS network 106 or the PS network 108. The voice call manager 110 may have access to the credit and accounting information for a user account for the VoIP service through the VoIP application component 114. Accordingly, the voice call manager 110 may select a network to use for a voice call based, in part, on credit or accounting information of the VoIP application component 114.

The signal detecting component 116 may include hardware and/or software code executable by a processor for detecting wired, such as, Ethernet or telephone landline, or wireless signals, such as cellular voice or data signals, WiFi signals, Bluetooth signals, or Near Field Communication (NFC) signals. In an aspect, for example, the signal detecting component 116 may include an antenna, receive chain, and/or receiver. Thus, signal detecting component 116 may detect communication signals that may be available to communication device 102 for making voice calls. The signal detecting component 116 may determine a signal strength of the available signals. For example, the signal detecting component 116 may determine a received signal strength indicator (RSSI) of a wireless network. The signal detecting component 116 may further obtain information about an available wireless network by reading broadcast information. For example, the signal detecting component 116 may read system information blocks (SIBs) of a broadcast channel to determine whether the communication device 102 may connect to the network.

The registration component 118 may include hardware and/or software code executable by a processor for managing and/or performing aspects of a registration of the communication device 102 with one or more wireless networks and/or services. In an aspect, for example, the communication device 102 may be registered with a PS network 108 such as an LTE network. The communication device 102 may additionally register with the VoIP server 130 when the PS network 108 is selected. In an aspect, the registration component 118 may register the communication device 102 with the CS network 106 during a CSFB procedure.

Communication device 102 also may include a microphone 120 configured to receive audio signals. For example, microphone 120 may capture a user's voice for making a voice call. Communication device 102 may also include a speaker 122 configured to emit audio sound. For example, speaker 122 may emit voice of a user of communication device 104 when communication device 102 is having a voice call with communication device 104. Communication device 102 may also include a user interface 124. The user interface 124 may include a touch screen, buttons, switches, sensors, or other hardware for enabling a user to interact with the communication device 102. For example, a user may use the user interface 124 to initiate a voice call by entering a number, selecting a contact, or otherwise indicating a called party. In an aspect, the user interface 124 may activate the voice call manager 110 for any voice call.

Communication device 104 may have similar components as communication device 102. Communication device 104 may be configured to make and receive voice calls via CS network 106 and/or PS network 108. Thus, communication device 104 may communicate voice calls with communication device 102 via CS network 106 and/or PS network 108. In an aspect, when the communication device 102 initiates a voice call to the communication device 104, the communication device 102 may be considered an originating device and the communication device 104 may be considered a termination device. The voice call may be referred to as a MO call at the communication device 102 and referred to as a MT call at the communication device 104.

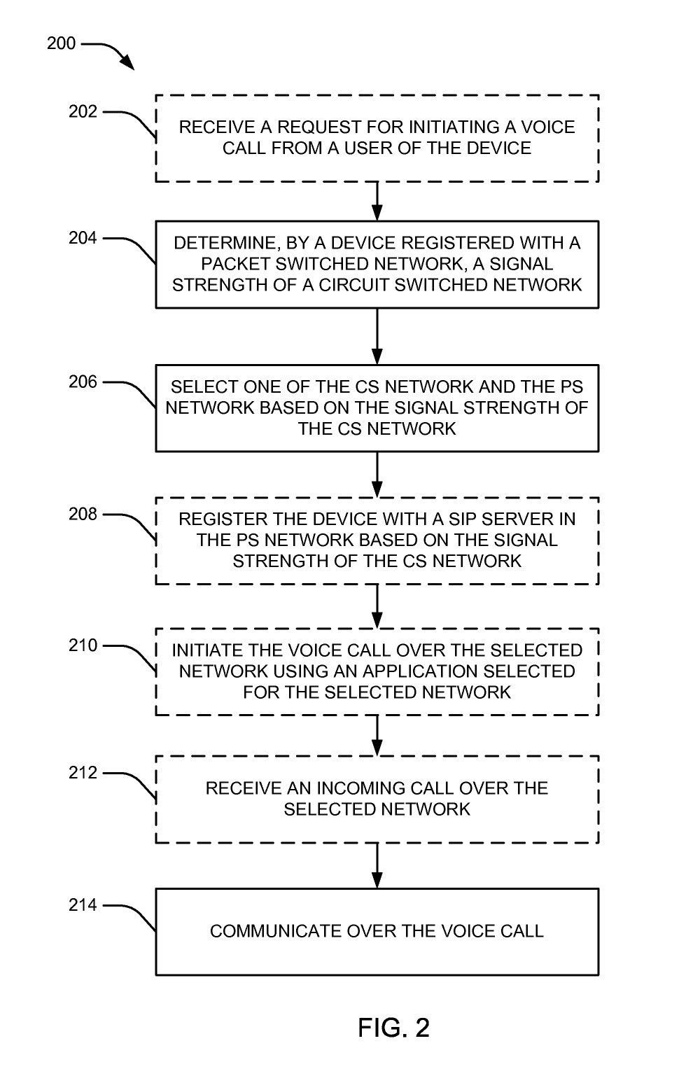

Referring to FIG. 2, in an operational aspect, a communication device such as communication device 102 (FIG. 1) may perform an aspect of a method 200 of wireless communication. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

At block 202, the method 200 may optionally include receiving a request for initiating a voice call from a user of the device. In an aspect, for example, the user interface 124 (FIG. 1) may receive a request for initiating a voice call from a user of the device (e.g., communication device 102 in FIG. 1). The user may indicate a desire to initiate a voice call through the user interface 124 without specifically identifying how the voice call should be made. That is, the user may select a contact, enter a number, or otherwise indicate a party to be called though a generic voice manager that selects the network for the voice call.

At block 204, the method 200 may include determining, by a device registered with a packet switched network, a signal strength of a circuit switched network. In an aspect, for example, the signal detecting component 116 (FIG. 1) may determine a signal strength of the CS network (e.g., CS network 106 in FIG. 1). The signal detecting component 116 may determine, for example, an RSSI of the CS network 106. The signal detecting component 116 may also receive and decode broadcast information from the CS network 106 that may be useful for determining the suitability of the CS network 106 for a voice call. The communication device 102 may be registered with the PS network 108 when the signal detecting component 116 determines the signal strength of the CS network 106. In an aspect, the communication device 102 may not be registered with the CS network 106 when the signal strength is detected.

At block 206, the method 200 may include selecting a network from one of the CS network and the PS network based on the signal strength of the CS network. In an aspect, for example, the voice call manager 110 (FIG. 1) may select a network from one of the CS network 106 and the PS network (e.g., PS network 108 in FIG. 1) based on the signal strength of the CS network. For example, the voice call manager may compare the signal strength of the CS network 106 to a threshold to determine whether to use the CS network for the voice call. If the signal strength of the CS network 106 exceeds the threshold, the voice call manager 110 may select the CS network 106. Otherwise, the voice call manager 110 may select the PS network 108. The voice call manager 110 may also select a VoIP application for making the voice call. For example, the voice call manager 110 may select a VoIP application based on credit and accounting information for an account associated with the VoIP application.

At block 208, the method 200 may optionally include registering the device with a VoIP server over the PS network based on the signal strength of the CS network. In an aspect, for example, the registration component 118 (FIG. 1) may register the communication device 102 with a SIP server (e.g. VoIP server 130 in FIG. 1) in the PS network based on the signal strength of the CS network. The registration component 118 may register the communication device 102 with the SIP server when the signal strength of the CS network 106 is poor. For example, the registration component 118 may compare the signal strength of the CS network 106 with a threshold value, and register the communication device 102 when the signal strength is less than the threshold value. The threshold value used for registering the communication device 102 with the SIP server may be the same threshold value used in block 206 for selecting the network. The registration component 118 may register the communication device 102 with the SIP server within the PS network 108 is the selected network.

At block 210, the method 200 may include initiating the voice call over the selected network using an application selected for the selected network. In an aspect, for example, the voice call manager 110 may initiate the voice call over the selected network using either the phone call application component 112 (FIG. 1) or the VoIP application component 114 (FIG. 1). The phone call application component 112 may be used to initiate the voice call over the CS network 106. The VoIP application component 114 may be used to initiate the voice call over the PS network 108. Accordingly, the voice call may be established over the selected network by initiating the voice call over the selected network.

At block 212, the method 200 may include receiving an incoming call over the selected network. In an aspect, for example, the voice call manager 110 may receive an incoming call over the selected network using either the phone call application component 112 or the VoIP application component 114. The network used by the incoming call may depend on whether the communication device 102 is registered with a SIP server. If the communication device 102 is registered with a SIP server, the incoming call may arrive via the PS network 108 and the VoIP application component 114. If the communication device 102 is not registered with a SIP server, the incoming call may arrive via a CSFB procedure to the CS network 106. Accordingly, the voice call may be established over the selected network by receiving the voice call over the selected network.

At block 214, the method 200 may include communicating over the voice call using the selected network. In an aspect, for example, the communication device 102 may communicate over the voice call established using the selected network. For example, the microphone 120 may receive sound, a vocoder may convert the sound to signals to be transmitted over the selected network. As another example, the speaker 122 may convert received signals to sounds.

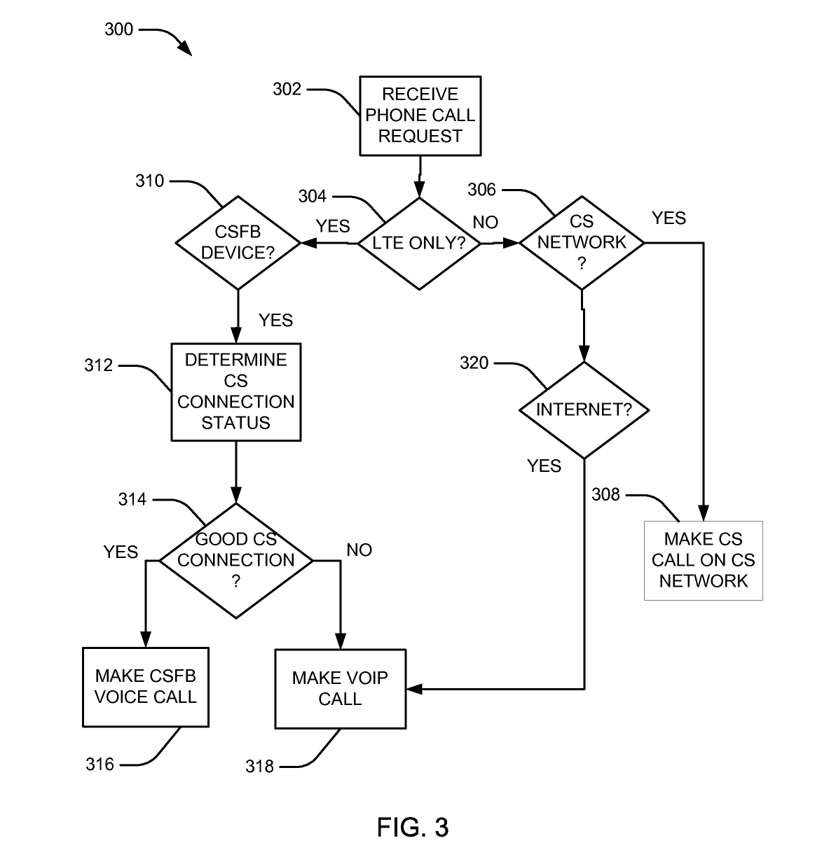

Referring to FIG. 3, a method 300 for making a voice call is illustrated by a flow chart. At block 302, communication device 102 may receive a request for making a voice call. For example, a user of communication device 102 may dial a phone number of communication device 104 to make a voice call with communication device 104. At block 304, communication device 102 may determine whether communication device 102 is camped on LTE only. If communication device 102 is not camped on LTE, communication device 102 may determine whether communication device 102 is camped on CS network 106 at block 306. If communication device 102 is camped on CS network 106, communication device 102 may make a voice call via CS network at block 308. Making a CS voice call may be a preferred method because CS may provide a dedicated channel for the voice call and may have better call quality. If communication device 102 is not camped on CS network 106, communication device 102 may determine whether any internet connection is available to communication device at block 320. For example, communication device 102 may have internet connection via one or more of WiFi, Bluetooth, NFC, Ethernet or the like. If communication device 102 has internet connection, communication device 102 may make a VoIP call via the internet connection at block 318.

If communication device 102 is camped on LTE only at block 304, communication device 102 may determine if communication device 102 is a CSFB device at block 310. If communication device 102 is a CSFB device, communication device 102 may determine a CS connection status of communication device 102 at block 312. Communication device 102 may detect a signal strength of a cell tower of CS network 106 and determine if there is a signal and whether the signal strength is above a certain threshold. For example, communication device 102 may detect a Received Signal Code Power (RSCP) of a CDMA 1x network, read broadcast information from the cell, determine a Tracking Area Code (TAC), or the like to determine the signal strength. The threshold may be a value of signal strength by which a signal reception is acceptable for making a successful voice call at communication device 102.

At block 314, communication device 102 may determine whether a successful CSFB voice call may be made by comparing the CS signal strength and the threshold value. If a successful CSFB voice call may be made, communication device 102 may make a CSFB voice call at block 316. If a successful CSFB voice call may not be made, communication device 102 may make the voice call using VoIP at block 318. In an embodiment, if no or weak LTE signal, communication device 102 may find internet connection via WiFi or other means and make a VoIP call via WiFi. For example, communication device 102 may select an appropriate OTT VoIP application or a pre-selected VoIP application to make the VoIP voice call. In another embodiment, communication device 102 may allow the user to choose from a plurality of VoIP apps to make the voice call.

In some embodiments, attempts to make a CS voice call may be done first. If CS voice call attempts failed and if a Packet Switched connection, e.g., WiFi, is available to communication device 102, communication device 102 may automatically make a voice call using the PS data connection for the user. The VoIP application may be pre-selected by the user before the CS voice call fails. In another embodiment, after the CS voice call fails, alternative applications may be presented to the user for selection to make a VoIP voice call.

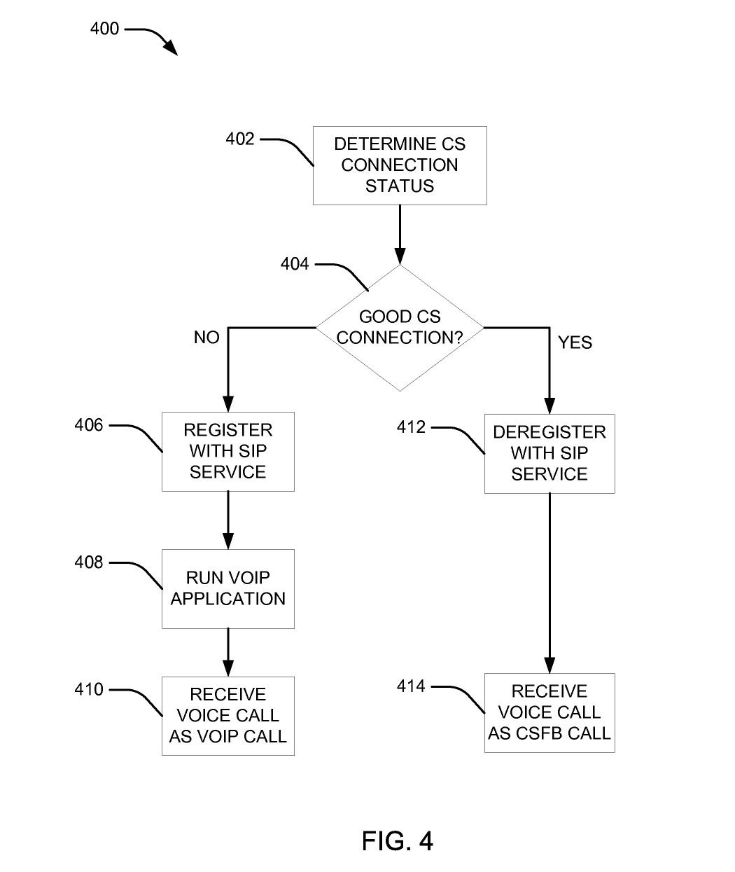

Referring to FIG. 4, a method 400 for making a voice call is illustrated by a flow chart. At block 402, the method 400 may include determining a CS network connection status. The communication device 102 may determine whether a connection to a CS network 106 is available. The communication device 102 may also determine a signal strength of the CS network 106 to determine whether the CS network is adequate to provide a voice call. At block 404, the method 400 may include determining whether the CS network provides a good connection. The communication device 102 may compare the signal strength to a threshold value to determine whether the CS network provides a good connection. If the CS connection not good, at block 406, the method 400 may include registering with a SIP service. The communication device 102 may provide a SIP Tel uniform resource identifier (URI) to a SIP server to register the communication device with the SIP service. At block 408, the communication device 102 may run a VoIP application. The VoIP application may maintain a connection with the SIP service and prepare to receive incoming VoIP calls. At block 410, the communication device 102 may receive a voice call as a VoIP call.

At block 412, if the CS connection is good, the method 400 may include deregistering with the SIP service. The communication device 102 may send a request for the SIP server to remove the SIP Tel URI. At block 414 the communication device 102 may receive a voice call as a CSFB call. The communication device 102 may be paged through a network such as an LTE network to switch to the CS network 106 for a CS voice call. The communication device 102 may switch to the CS network 106 and establish a connection for the voice call.

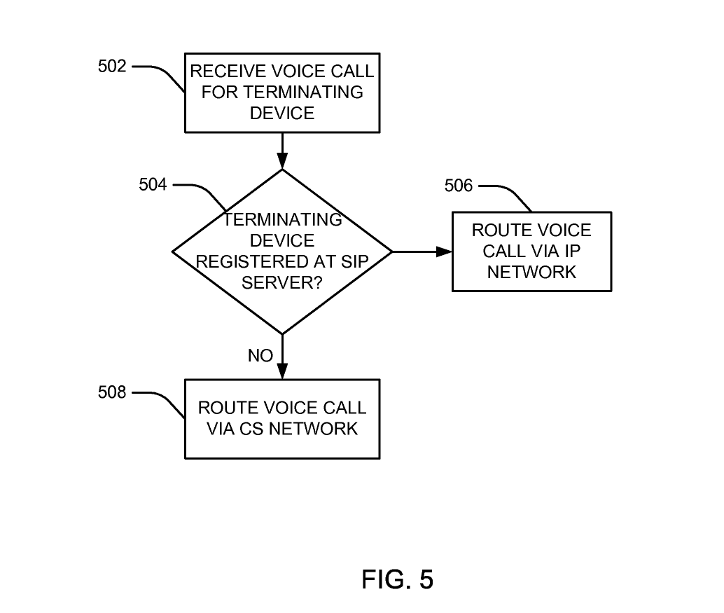

Referring to FIG. 5, a method 500 for routing a voice call to a communication device according to an aspect of the present disclosure is illustrated by a flow chart. At block 502, a request for routing a voice call to a terminating device, e.g., communication device 104, may be received. At block 504, a media gateway (IP/CS) in the operator's network may determine whether termination device is registered at a Session Initiation Protocol (SIP) server. For example, the process may use a SIP stack on the VoIP client of the terminating device and the SIP server on the operator network. If the terminating device is in an area where CS signal strength is below the threshold, the terminating device may deregister from CS domain and register using its SIP Tel URI with a SIP server on the operator's network. Registration with the SIP server may be an indication that the incoming voice call should be routed via PS network 108. The SIP registration and deregistration may be based on the CS RAT signal detected or from broadcast information from the cell that communication device 102 is camped or connected to be indicative of the ability of communication device 102 to receive the voice calls via CS or VoIP.

A media gateway of the operator's network may route the voice call based on an incoming call number associated with the terminating device. The media gateway also may decide to route the voice call via packet gateway (PGW) of the core network (CN) or the Mobile services Switching Centre (MSC) after querying the SIP server whether the terminating device is registered at the SIP Server. If the terminating device is registered at the SIP server, the voice call may be routed via PS network 108 at block 506. If the terminating device is not registered at the SIP server, the voice call may be routed via CS network 106 at block 510.

In some embodiments, a communication device in an LTE small cell (also called Home eNodeB) coverage may perform periodic searches for CDMA 1x signals at certain intervals to determine whether the communication device is to maintain SIP registration or receive voice call via CS network 106. Thus, the communication device may indicate, by registration with the SIP server, whether the communication device may receive voice calls via CS network or via IP network. From the voice call originator's perspective reaching the media gateway, this is similar to when the voice call originator calls a VoIP subscriber over WiFi in current PSTN. The voice call originator may dial a number and the media gateway (telephone exchange) may determine that the call is to be routed to the VoIP SIP server.

By using a SIP server connected to an operator's media gateway, a voice call may selectively be routed in CS or IP domain. No changes are required in Evolved Packet Core (EPC) or CN of LTE. This capability to choose CSFB or VoIP over a PS network such as LTE or WiFi for the a voice call on the communication device also may be useful for emergency voice call origination.

The above systems and processes may allow intelligent selection of an application for making a voice call. In particular, a voice call may be placed via a CS network (CSFB) from LTE or a VoIP call using LTE or WiFi based on the CS network's availability and the quality of the underlying 1x/GSM/UMTS network. It is especially beneficial in dual mode (LTE/WiFi) Femto cells, which are typically indoors, with LTE only and with weak or no CDMA 1x macro coverage for reselection to place a CSFB call. Further, it is useful to non-CSFB communication devices and non-IP Multimedia Subsystem (IMS) capable phones. CN with Telephony Application Server (TAS) and SIP server interacting with media gateways as existing in operator's network may be used for routing incoming voice calls to a terminating mobile device.

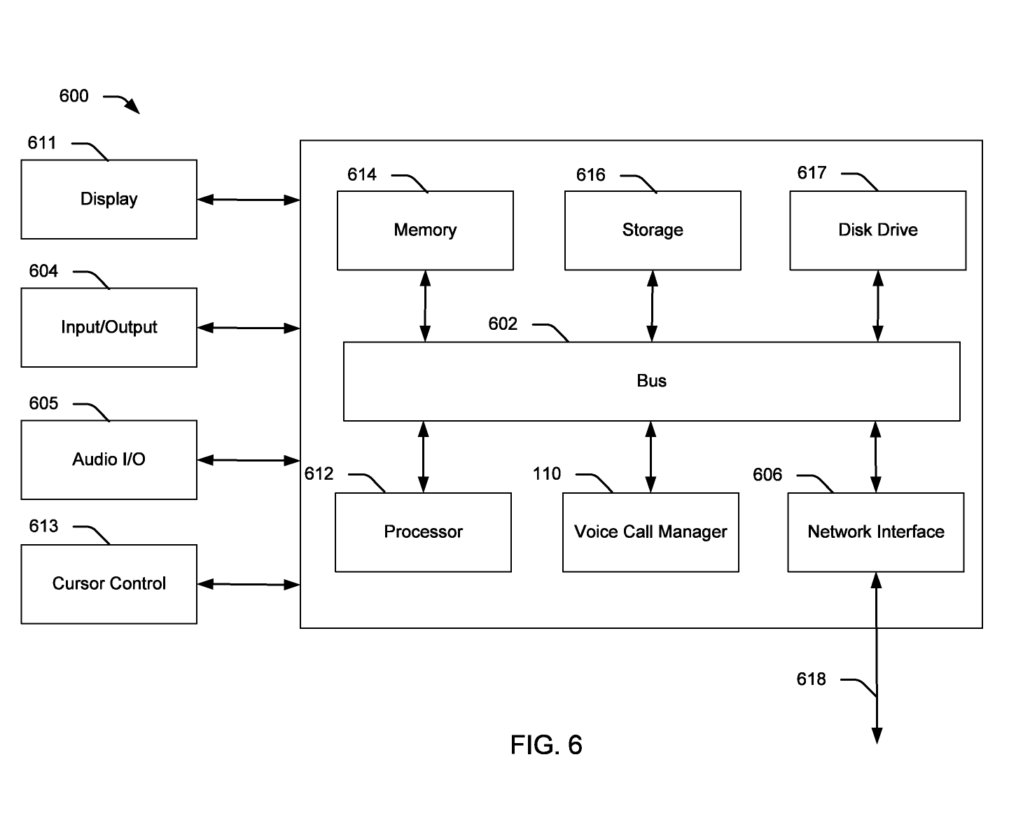

FIG. 6 is a block diagram of a computer system 600 suitable for managing voice calls for a CSFB-capable communication device (e.g. communication device 102 in FIG. 1) according to one embodiment of the subject matter of the present disclosure. Computer system 600 may include or implement a plurality of hardware components and/or software components that operate to perform various methodologies in accordance with the described embodiments. In one aspect of implementation, computer system 600 may include a voice call manager 110 (FIG. 1), such as in specially programmed computer readable instructions or code, firmware, hardware, or some combination thereof.

Computer system 600 may include a bus 602 or other communication mechanism for communicating data, signals, and information between various components of computer system 600. Components may include an input/output (I/O) component 604 that processes user action, such as detecting users scrolling actions in an application, clicking on links, or entering URLs of webpages, etc., and sends a corresponding signal to bus 602. I/O component 604 may also include an output component such as a display 611 for displaying the browser window, an input component such as a camera 607, and an input control such as a cursor control 613 (such as a virtual keyboard, virtual keypad, virtual mouse, etc.). An audio input/output component 605 may also be included to allow a user to use voice for inputting information by converting audio signals into information signals. Audio I/O component 605 may allow the user to hear audio. A transceiver or network interface 606 may transmit and receive signals between computer system 600 and other devices, such as another communication device, or another network computing device via a communication link 618 to a network. In an aspect, the network interface 606 may include a modem for wireless communications. In one aspect, the transmission is a cellular/wireless communication, although other transmission mediums and methods may also be suitable. A processor 612, which may comprise a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also may include a system memory component 614 (e.g., RAM), a static storage component 616 (e.g., ROM), and/or a disk drive 617. Computer system 600 may perform specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, such as storage component 616 or disk drive 617; volatile media includes dynamic memory, such as system memory component 614; and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

In an aspect, voice call manager 110 may be a separate component connected to the bus 602. In an aspect, the voice call manager 110 as described above may be implemented in whole or in part by processor 612, or by a computer-readable medium such as memory 614, storage 616, or disk drive 617, or by any combination of processor 612 and one or more of memory 614, storage 616, and disk drive 617. For example, instructions for managing voice calls for a communication device may be stored in the computer readable medium of system memory component 614, storage component 616, or disk drive 617 for execution by processor 612. Processor 612 may execute the instructions to determine an application or network for making or receiving a voice call.

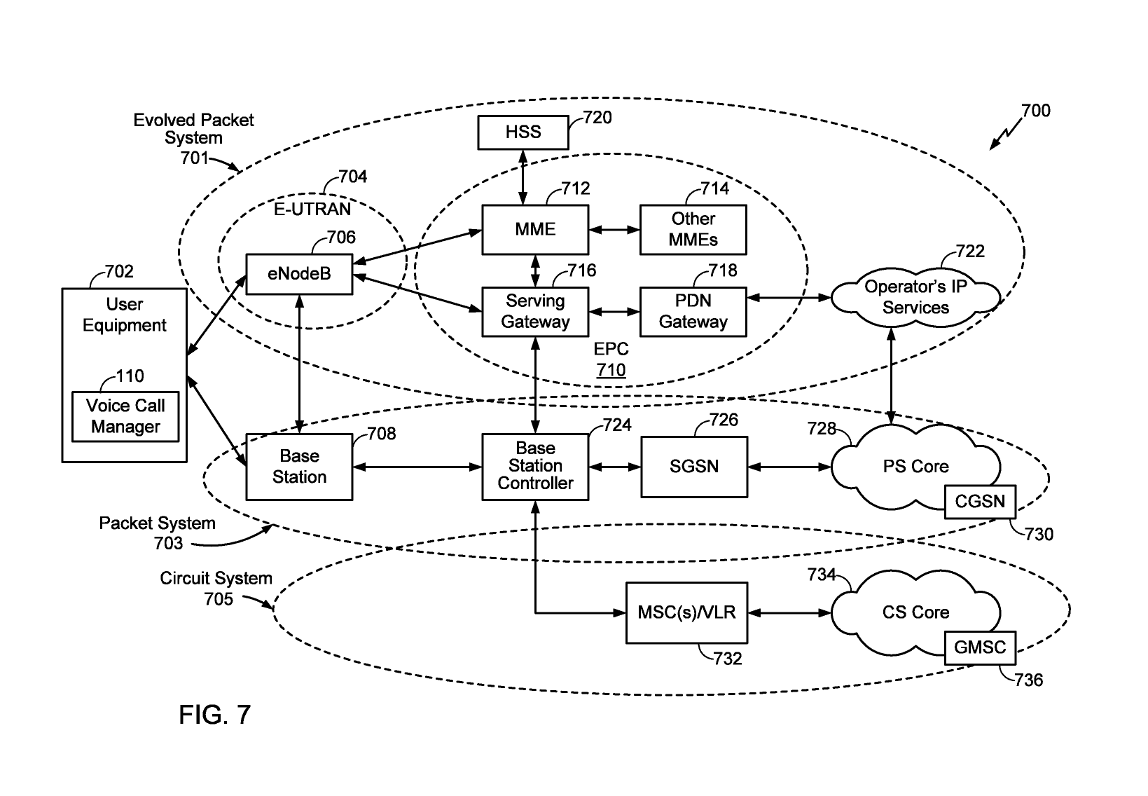

FIG. 7 shows a diagram illustrating a wireless network architecture 700 employing various apparatuses including a UE 702 having a voice call manager 110 for selecting a network for a voice call, in accordance with aspects of the disclosure. The network architecture 700 may include an Evolved Packet System (EPS) 701. The EPS 701 may be considered a PS network. The EPS 701 may include one or more user equipment (UE) 702, an Evolved UMTS Terrestrial Radio Access Network (E-UTRAN) 704, an Evolved Packet Core (EPC) 710, a Home Subscriber Server (HSS) 720, and an Operator's IP Services 722. The EPS may interconnect with other access networks, such as a packet switched core (PS core) 728, a circuit switched core (CS core) 734, etc. As shown, the EPS provides packet-switched services, however, as those skilled in the art will readily appreciate, the various concepts presented throughout this disclosure may be extended to networks providing circuit-switched services, such as the network associated with CS core 734.

The network architecture 700 may further include a packet switched network 703 and/or a circuit switched network 705. In one aspect, the packet switched network 703 may include base station 708, base station controller 724, Serving GPRS Support Node (SGSN) 726, PS core 728 and Combined GPRS Service Node (CGSN) 730. In another aspect, the circuit switched network 705 may include base station 708, base station controller 724, Mobile services Switching Centre (MSC), Visitor location register (VLR) 732, CS core 734 and Gateway Mobile Switching Centre (GMSC) 736.

The E-UTRAN may include an evolved Node B (eNB) 706 and connection to other networks, such as packet and circuit switched networks may be facilitated through base station 708. The eNB 706 provides user and control plane protocol terminations toward the UE 702. The eNB 706 may be connected to the other eNBs (not shown) via an X2 interface (e.g. backhaul). The eNB 706 may also be referred to by those skilled in the art as a base station, a base transceiver station, a radio base station, a radio transceiver, a transceiver function, a basic service set (BSS), an extended service set (ESS), or some other suitable terminology. The eNB 706 provides an access point to the EPC 710 for a UE 702. The UE 702 may be an example of the communication device 102 (FIG. 1) and include a voice call manager 110 for selecting between the EPS 701, PS network 703, and CS network 705 for establishing a voice call.

The eNB 706 is connected by an S1 interface to the EPC 710. The EPC 710 includes a Mobility Management Entity (MME) 712, other MMEs 714, a Serving Gateway 716, and a Packet Data Network (PDN) Gateway 718. The MME 712 is the control node that processes the signaling between the UE 702 and the EPC 710. Generally, the MME 712 provides bearer and connection management. All user IP packets are transferred through the Serving Gateway 716, which itself is connected to the PDN Gateway 718. The PDN Gateway 718 provides UE IP address allocation as well as other functions. The PDN Gateway 718 is connected to the Operator's IP Services 722. The Operator's IP Services 722 may include the Internet, the Intranet, an IP Multimedia Subsystem (IMS), and a PS Streaming Service (PSS).

In an aspect of the disclosure, the network architecture 700 may be enabled to facilitate circuit switched fallback (CSFB). In an aspect, when a phone number is dialed to place a CS call, if the UE was camped on an LTE network, a CSFB procedure may be employed. The CSFB procedure may move the UE from an LTE cell to a CS based cell, such as UTRAN, GERAN, etc., where the CS call setup may occur using legacy CS call setup procedures. The term “cell” can refer to a coverage area of an eNB or base station and/or an eNB or base station subsystem serving this coverage area. As used herein, CSFB may refer to establishing a signaling channel between a circuit switched MSC 732 and the LTE EPC 710 to allow for services, such as voice calls, short message service (SMS), etc. In an implementation, when a UE 702 is moved from an EPS 701 to a 3GPP network, such as a CS network 705 (UTRAN), a packet switched (PS) network 703, etc., the UE may perform one or more registration procedures prior to being able to communicate user data over the 3GPP network.

In an aspect of the disclosure, although the description may provide examples through use of a UTRAN system, it should be appreciated that other RATs, such as GERAN, etc., may be used.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

In an aspect, upon power up, UE 702 may search for wireless networks from which it can receive communication services. If more than one wireless network is detected, then a wireless network with the highest priority may be selected to serve UE 702 and may be referred to as the serving network. UE 702 may perform registration with the serving network, if necessary. UE 702 may then operate in a connected mode to actively communicate with the serving network. Alternatively, UE 702 may operate in an idle mode and camp on the serving network if active communication is not required by UE 702.

UE 702 may be located within the coverage of cells of multiple frequencies and/or multiple RATs while in the idle mode. For LTE, UE 702 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 702 may be configured to prefer LTE, when available, by defining the priority list with LTE frequencies at the highest priority and with frequencies for other RATs at lower priorities, e.g. as given by the example above.

UE 702 may operate in the idle mode as follows. UE 702 may identify all frequencies/RATs on which it is able to find a “suitable” cell in a normal scenario or an “acceptable” cell in an emergency scenario, where “suitable” and “acceptable” are specified in the LTE standards. UE 702 may then camp on the frequency/RAT with the highest priority among all identified frequencies/RATs. UE 702 may remain camped on this frequency/RAT until either (i) the frequency/RAT is no longer available at a predetermined threshold or (ii) another frequency/RAT with a higher priority reaches this threshold. This operating behavior for UE 702 in the idle mode is described in 3GPP TS 36.304, entitled “Evolved Universal Terrestrial Radio Access (E-UTRA); User Equipment (UE) procedures in idle mode,” which is publicly available.

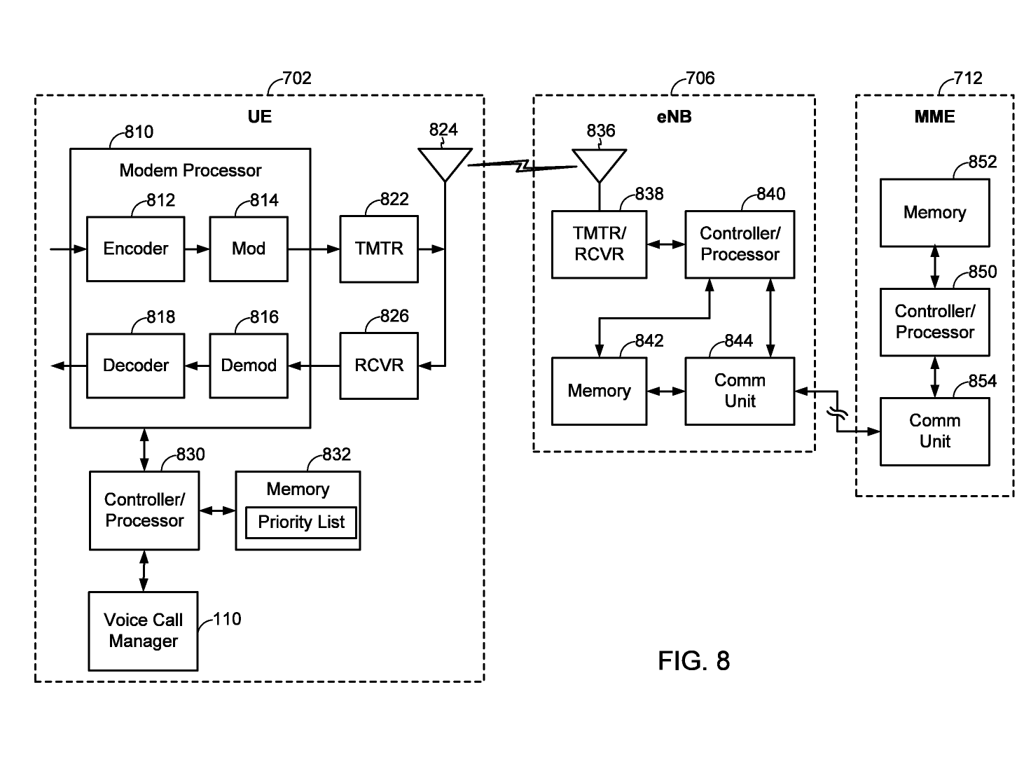

FIG. 8 shows a block diagram of a design of UE 702, eNB 706, and MME 712 in FIG. 7. The UE 702 may, as described above, include a voice call manager 110 for selecting a network for a voice call. At UE 702, an encoder 812 may receive traffic data and signaling messages to be sent on the uplink. Encoder 812 may process (e.g. format, encode, and interleave) the traffic data and signaling messages. A modulator (Mod) 814 may further process (e.g. symbol map and modulate) the encoded traffic data and signaling messages and provide output samples. A transmitter (TMTR) 822 may condition (e.g. convert to analog, filter, amplify, and frequency upconvert) the output samples and generate an uplink signal, which may be transmitted via an antenna 824 to eNB 706. The UE 702 described in FIG. 8 may further include the voice call manager 110 as shown in FIG. 7. The voice call manager 110 may interact with the modem processor 810, the controller/processor 830, and/or the memory 832. In an aspect, the voice call manager 110 may be implemented in whole or in part by controller/processor 830, or by memory 832 or by any combination of controller processor 830 and memory 832.

On the downlink, antenna 824 may receive downlink signals transmitted by eNB 706 and/or other eNBs/base stations. A receiver (RCVR) 826 may condition (e.g. filter, amplify, frequency down-convert, and digitize) the received signal from antenna 824 and provide input samples. A demodulator (Demod) 816 may process (e.g. demodulate) the input samples and provide symbol estimates. A decoder 818 may process (e.g. de-interleave and decode) the symbol estimates and provide decoded data and signaling messages sent to UE 702. Encoder 812, modulator 814, demodulator 816, and decoder 818 may be implemented by a modem processor 810. These units may perform processing in accordance with the RAT (e.g. LTE, 1xRTT, etc.) used by the wireless network with which UE 702 is in communication.

A controller/processor 830 may direct the operation at UE 702. Controller/processor 830 may also perform or direct other processes for the techniques described herein. Controller/processor 830 may also perform or direct the processing by UE 702 in FIGS. 2-5. Memory 832 may store program codes and data for UE 702. Memory 832 may also store a priority list and configuration information. The priority list may indicate that the UE 702 should camp on the eNB 706 or another eNB of an LTE network if available.

At eNB 706, a transmitter/receiver 838 may support radio communication with UE 702 and other UEs. A controller/processor 840 may perform various functions for communication with the UEs. On the uplink, the uplink signal from UE 702 may be received via an antenna 836, conditioned by receiver 838, and further processed by controller/processor 840 to recover the traffic data and signaling messages sent by UE 702. On the downlink, traffic data and signaling messages may be processed by controller/processor 840 and conditioned by transmitter 838 to generate a downlink signal, which may be transmitted via antenna 836 to UE 702 and other UEs. Controller/processor 840 may also perform or direct other processes for the techniques described herein. Controller/processor 840 may also perform or direct the processing by eNB 706 in FIGS. Memory 842 may store program codes and data for the base station. A communication (Comm) unit 844 may support communication with MME 712 and/or other network entities.

At MME 712, a controller/processor 850 may perform various functions to support communication services for UEs. For example, the MME 712 may be in communication with a media gateway and/or SIP server for routing voice calls to a UE 702. Controller/processor 850 may also perform or direct the processing by MME 712 in FIG. 5. Memory 852 may store program codes and data for MME 712. A communication unit 854 may support communication with other network entities.

FIG. 8 shows simplified designs of UE 702, eNB 706, and MME 712. In general, each entity may include any number of transmitters, receivers, processors, controllers, memories, communication units, etc. Other network entities may also be implemented in similar manner.

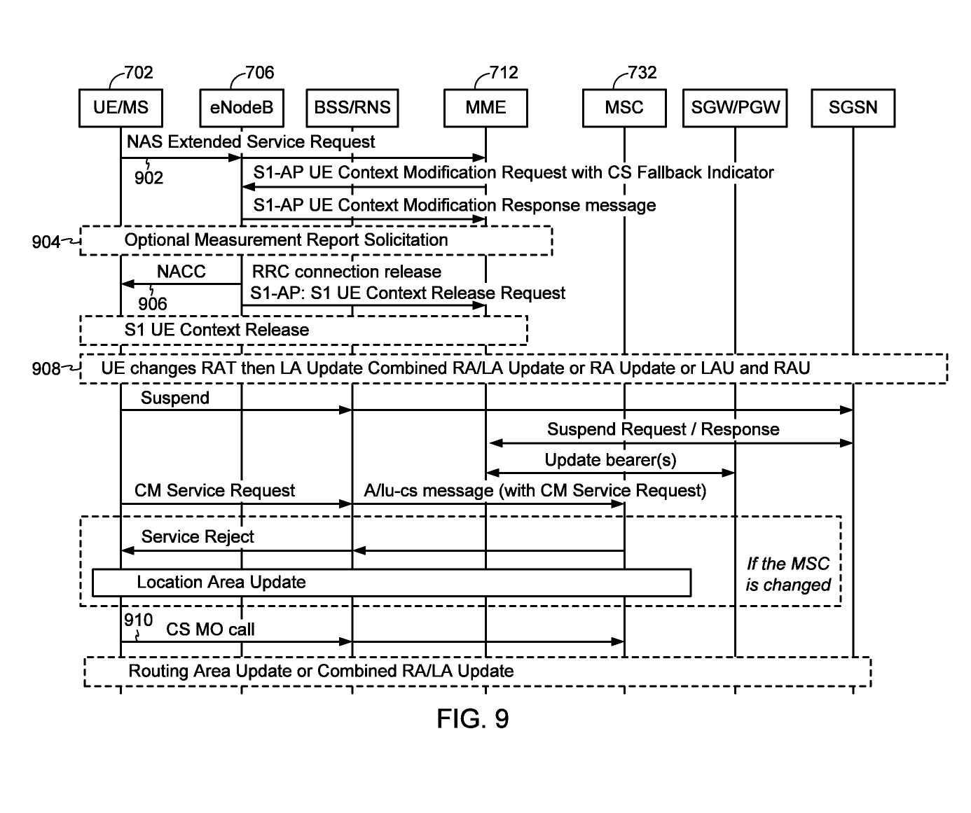

FIG. 9 illustrates an example call flow of CSFB when a UE 702 makes a mobile originating (MO) call, according to certain aspects of the present disclosure. For example, the voice call manager 110 may choose to use CSFB while the UE 702 is camped on an LTE network (eNB 706) that may not support voice services. The voice call manager 110 may choose to fallback to a GSM/UMTS network connected to the MSC 732 in order to make the MO call rather than initiating the MO call over a PS network such as an LTE network associated with eNB 706. The call setup procedure may begin at 902 where the UE 702 may send a non access stratum (NAS) extended service request (ESR) to the MME 712. The ESR may comprise a CSFB indicator that informs the MME 712 to perform CSFB. In response to the ESR, the MME 712 may indicate to the eNB 706 that the UE 702 should be moved to a GSM/UMTS network.

At 904, the eNB 706 may receive a measurement report from the UE 702 to determine CS RAT candidates to which the redirection procedure may be performed. At 906, the LTE network may assist the UE 702 in the mobility procedure (e.g. reselection, redirection, handover, or network assisted cell change (NACC)). For example, if an interface between the MSC 732 and the MME 712 is down, the LTE network may inform the UE 702 to retry the call setup after a set period of time. For some embodiments, the eNB 706 may trigger an inter-RAT cell change order with the NACC to a GSM cell by sending an RRC message to the UE 702. The inter-RAT cell change order may contain a CSFB indicator that indicates to the UE 702 that the cell change order is triggered due to a CSFB request.

At 908, the UE 702 may move to the new GSM cell, using, for example, the NACC information and establishing the radio signaling connection. At 910, the UE may initiate the CS MO call. A similar procedure may be used to move the UE 702 to a 1xCDMA or WCDMA cell.

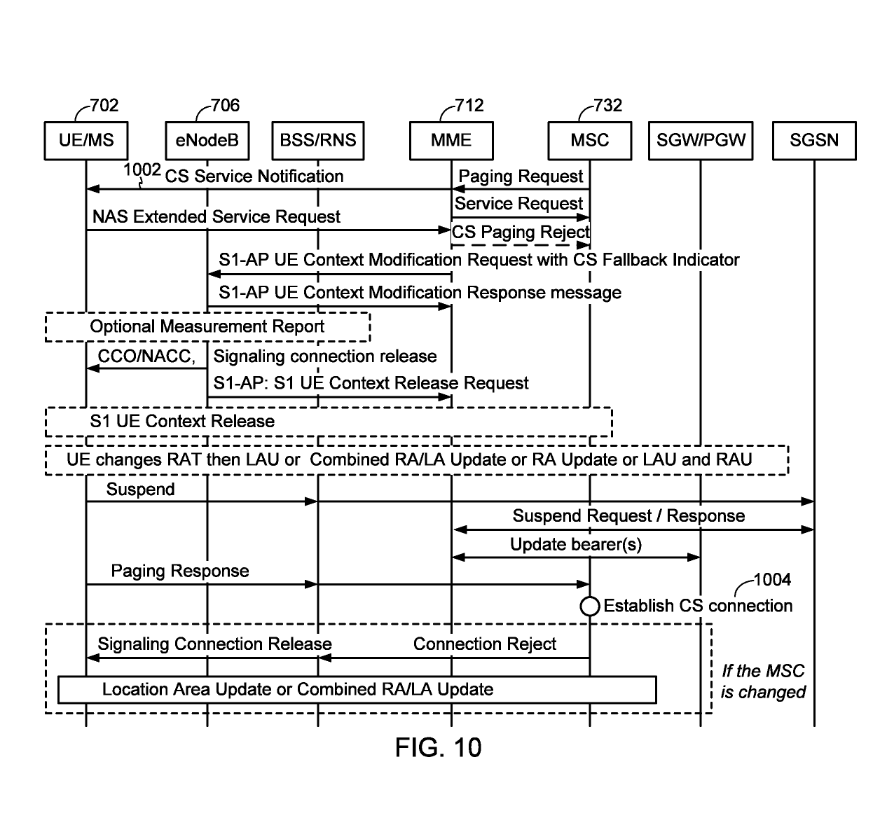

FIG. 10 illustrates an example call flow of CSFB when a UE 702 receives a mobile terminating (MT) call, according to certain aspects of the present disclosure. For example, the UE 702 may not be registered with a VoIP server 130 (FIG. 1) because the voice call manager 110 has selected the CS network (e.g. CS network 106 in FIG. 1) based on the signal strength of the CS network. The UE 702 may receive a voice call over a CS network using the CSFB procedure in FIG. 10. Operations may be similar to those described in FIG. 9, however, the UE 702 may initiate the call setup procedure after receiving a GSM/UMTS page at 1002 (e.g. CS SERVICE NOTIFICATION). For example, the MSC 732 may receive an incoming voice call and respond by sending a paging request to the MME 712. The eNB 706 may forward the paging message to the UE 702. At 1004, if the UE 702 is registered in the MSC 732 serving a GSM/UMTS cell, the MSC 732 may establish the CS MT call.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method of managing voice calls for wireless communications, comprising:
determining, by a device registered with a packet switched (PS) network, a signal strength of a circuit switched (CS) network at the device;
selecting, based on the signal strength of the CS network, a network from one of the CS network and the PS network for a voice call; and
establishing the voice call using the selected network.

2. The method of claim 1, wherein establishing the voice call comprises:
receiving a request for initiating the voice call from a user of the device; and
initiating, in response to the request, the voice call over the selected network, automatically, using an application for the voice call over the selected network.

3. The method of claim 1, wherein the CS network is selected when the signal strength of the CS network is above a threshold.

4. The method of claim 1, wherein the PS network is selected when the signal strength of the CS network is not above a threshold.

5. The method of claim 1, wherein the CS network comprises one of a CDMA 2000 1x network, a WCDMA network, or a GSM network.

6. The method of claim 1, wherein the device is a voice centric Circuit Switched Fall Back (CSFB) communications device configured to communicate using one or both of the PS network and the CS network.

7. The method of claim 1, further comprising additionally registering the device with a voice over internet protocol (VoIP) service over the PS network based on the signal strength of the CS network.

8. The method of claim 7, wherein registering the device with the VoIP service over the PS network based on the signal strength of the CS network includes registering with the VoIP service when the signal strength of the CS network is less than a threshold.

9. The method of claim 8, further comprising:
running a VoIP application while registered with the VoIP service; and
receiving a request to join the voice call through the VoIP application.

10. The method of claim 8, further comprising deregistering with the VoIP service when the signal strength of the CS network exceeds a threshold.

11. The method of claim 10, further comprising receiving the voice call over the CS network using a circuit switched fallback (CSFB) procedure.

12. An apparatus for managing voice calls for wireless communications, comprising:
a signal detecting component configured to determine, at a device registered with a packet switched (PS) network, a signal strength of a circuit switched (CS) network at the device;
a voice call manager configured to select, based on the signal strength of the CS network, a network from one of the CS network and the PS network for a voice call;
a phone call application component configured to establish the voice call over the CS network when the CS network is selected; and
a voice over internet protocol (VoIP) application component configured to establish the voice call over the PS network when the PS network is selected.

13. The apparatus of claim 12, further comprising a user interface configured to receive a request for initiating the voice call from a user of the device; wherein the voice call manager is further configured to initiate, in response to the request, the voice call over the selected network, automatically, using one of the phone call application component or the VoIP application component corresponding to the selected network.

14. The apparatus of claim 13, wherein the voice call manager selects the CS network when the signal strength of the CS network is above a threshold.

15. The apparatus of claim 13, wherein the voice call manager selects the PS network when the signal strength of the CS network is not above a threshold.

16. The apparatus of claim 12, further comprising a registration component configured to additionally register the apparatus with VoIP service over the PS network based on the signal strength of the CS network.

17. The apparatus of claim 16, wherein the registration component is configured to register with the VoIP service when the signal strength of the CS network is less than a threshold.

18. The apparatus of claim 17, wherein the VoIP application component is configured to receive a VoIP voice call over the PS network through the VoIP service.

19. The apparatus of claim 17, wherein the registration component is configured to deregister with the VoIP service when the signal strength of the CS network exceeds the threshold.

20. The apparatus of claim 19, wherein the phone call application component is configured to receive a voice call over the CS network using a circuit switched fallback (CSFB) procedure.

21. An apparatus for managing voice calls for wireless communications, comprising:
means for determining, at a device registered with a packet switched (PS) network, a signal strength of a circuit switched (CS) network at the device;
means for selecting, based on the signal strength of the CS network, a network from one of the CS network and the PS network for a voice call; and
means for establishing the voice call using the selected network.

22. The apparatus of claim 21, further comprising:
means for receiving a request for initiating a voice call from a user of the device; and
means for initiating the voice call over the selected network, automatically, using an application for the voice call corresponding to the selected network.

23. The apparatus of claim 22, wherein the means for selecting is configured to select the CS network when the signal strength of the CS network is above a threshold.

24. The apparatus of claim 22, wherein the means for selecting is configured to select the PS network when the signal strength of the CS network is not above a threshold.

25. The apparatus of claim 21 further comprising means for registering the device with a voice over internet protocol (VoIP) service over the PS network based on the signal strength of the CS network.

26. The apparatus of claim 25, wherein the means for registering the device is configured to register with the VoIP service when the signal strength of the CS network is less than a threshold, and deregister with the VoIP service when the signal strength of the CS network exceeds the threshold.

27. The apparatus of claim 25, wherein the means for establishing the voice call using the selected network is configured to establish a VoIP voice call over the PS network through the VoIP service.

28. The apparatus of 25, wherein the means for establishing the voice call using the selected network is configured to establish the voice call over the CS network using a circuit switched fallback (CSFB) procedure.

29. A computer readable medium storing computer executable code, comprising:
code for determining, by a device registered with a packet switched (PS) network, a signal strength of a circuit switched (CS) network at the device;
code for selecting, based on the signal strength of the CS network, a network from one of the CS network and the PS network for a voice call; and
code for establishing the voice call using the selected network.

30. The computer readable medium of claim 29, wherein the code for selecting includes:
code for selecting the CS network when the signal strength of the CS network is above a threshold; and
code for selecting the PS network when the signal strength of the CS network is not above the threshold.
